(19) United States
(12) Patent Application Publication
(10) Pub. No.: US 2026/0288963 A1
(43) Pub. Date: Sep. 24, 2026

(54) COMMAND FILTER UPDATES

(71) Applicant: HEWLETT PACKARD ENTERPRISE DEVELOPMENT LP, Spring, TX (US)

(72) Inventors: Sukhamoy Som, Houston, TX (US); David F. Heinrich, Tomball, TX (US); Theodore F. Emerson, Tomball, TX (US)

(21) Appl. No.: 19/172,198

(22) Filed: Apr. 7, 2025

Related U.S. Application Data
(60) Provisional application No. 63/775,601, filed on Mar. 21, 2025.

(51) Int. Cl. G06F 21/57; G06F 21/56

(52) U.S. Cl. CPC G06F 21/57; G06F 21/566

(57) ABSTRACT

In some examples, during an initialization of the computer system or at runtime, a security system can validate program code to be run on a processing resource outside a security boundary of the security system. The security system can detect a condition triggering an update of a command filter in a memory controller for a memory. Based on detecting the condition, the security system can initiate an update of the command filter.

### CROSS REFERENCE TO RELATED APPLICATION

This application claims the benefit under 35 U.S.C. § 119(e) of U.S. Provisional Application No. 63/775,601, titled "Command Filter Updates," filed Mar 21, 2025 (Attorney Docket No. P176637USPRV), which is hereby incorporated by reference in its entirety.

### BACKGROUND

A computer system can include a memory to store information. The memory may include a volatile memory or a nonvolatile memory. Examples of information stored in the memory can include program code and data. Content stored in the nonvolatile memory is maintained even if power is removed from the nonvolatile memory. Content stored in the volatile memory is lost if power is removed from the volatile memory.

### BRIEF DESCRIPTION OF THE DRAWINGS

Some implementations of the present disclosure are described with respect to the following figures.

FIG. 1 is a block diagram of an arrangement including a computer system according to some examples.

FIG. 2 is a block diagram of a bus interface controller according to some examples.

FIG. 3 is a flow diagram of a process of a secure enclave according to some examples.

FIG. 4 is a block diagram of a security system according to some examples.

FIG. 5 is a block diagram of a computer system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Access to a memory (e.g., a nonvolatile memory or a volatile memory) in a computer system can be managed by a memory controller. A requester can issue access requests (e.g., read requests, write requests, erase requests, etc.) to the memory controller. In response to an access request, the memory controller can issue a command to the memory to perform the requested access operation. To protect the memory from unauthorized access, the memory controller can include a command filter to approve or reject an access request received at the memory controller from a requester (or access requests from multiple requesters). If the computer system has multiple memories, different memory controllers may manage access to the respective memories, and each memory controller can include its corresponding command filter.

A command filter in a memory controller includes a ruleset that governs which access requests are allowed or prohibited. For example, the ruleset can include an allow list that includes a list of access requests that are allowed by the command filter for a particular requester. Alternatively or additionally, the ruleset can include a deny list that includes a list of access requests that are to be rejected by the command filter. A ruleset can also specify additional criteria regarding whether an access request is to be allowed or rejected. The additional criteria can include an ownership criterion, an address range criterion, and/or another criterion. According to the ownership criterion, the command filter checks the owner of an access request, where the owner refers to the entity that submitted the access request. If the owner is an approved owner (i.e., the owner is part of an allow list of owners or the owner is not on a deny list of owners), then the command filter can allow the access request. If the owner is not an approved owner, the access request is blocked even though the access request passed the inspection based on the allow list of access requests and/or deny list of access requests. According to the address range criterion, the command filter checks if the access request is targeted at a valid address range. For example, the ruleset can specify which address ranges are permitted for respective different types of access requests. If an access request is targeted at a valid address range, the command filter can allow the access request. However, if an access request is not targeted at a valid address, the command filter blocks the access request.

In some cases, the ruleset of a command filter is fixed; in other words, once the command filter is set in the memory controller, the ruleset may not be modified. In some examples, preventing the modification of the ruleset of a command filter may be performed for security reasons. Once the computer system is deployed at a site, requests to modify the ruleset of a command filter may originate from entities that may not be trusted. In further examples, the ruleset of a command filter may not be modified after deployment because the computer system lacks the capability to modify the command filter.

For some other cases, if the command filter in a memory controller is fixed and cannot be modified after deployment of the computer system, then the memory controller may not operate in the intended manner due to changing conditions. An example of a changed condition includes a change of program code for a management controller (or another processing entity) in the computer system. For example, the computer system when delivered to a customer may include first program code for the management controller, where the first program code may be stored in the memory. However, the customer may desire to replace the first program code with second program code that is different from the first program code. Different rulesets for the command filter may be used if different program codes are loaded in the memory. If the command filter cannot be changed after the program code for the management controller in the memory is changed, then the memory controller may not properly filter access requests to the memory.

Other examples of changed conditions include infestation of the computer system by malware or the occurrence of bugs leading to errors or faults in the computer system. It may be determined that the command filter should be changed in response to detecting the malware or a bug. However, if the ruleset of the command filter is fixed, then such a change may not be possible, which raises a security risk or operational risk if the malware is able to access the memory or the bug leads to corruption of the information in the memory.

In accordance with some implementations of the present disclosure, a security system for a computer system includes a security controller to perform various security tasks in the computer system. For example, the security controller includes a hardware root of trust (HRoT) engine, also referred to as a silicon RoT (SRoT) engine, to perform initial security tasks during an initialization of the computer system. The HRoT engine can validate program code to be run on a processing resource outside a security boundary of the security system. The processing resource can be part of a management controller or can be part of a system central processing unit (CPU) of the computer system.

The security controller can detect a condition triggering an update of a command filter in a memory controller for a memory. Based on detecting the condition, the security controller can update the command filter, such as by modifying a ruleset of the command filter. The security controller that can update the command filter is fully trusted to ensure that the update of the command filter is authorized and not being performed by an attacker. The modification can include making a change to the ruleset, or replacing the ruleset with a different ruleset. The ruleset can include an allow list of access requests that are permitted for access to the memory. Alternatively or additionally, the ruleset can include a deny list of access requests to the memory that are to be rejected.

The ruleset can also include other rules, such as rules specifying an ownership criterion and an address range criterion. In an example where a ruleset includes multiple rules (e.g., a rule specifying an allow list or deny list of access requests), a rule specifying an ownership criterion, and a rule specifying an address range criterion), then the command filter checks to ensure all of the multiple rules of the ruleset before permitting an access request. Note that a ruleset may include multiple rules relating to the address range criterion for different types of access requests. For example, the ruleset may include a rule specifying one or more address ranges for a read request, and another rule specifying one or more address ranges for a write request. In further examples, for a given access request, if multiple address ranges are to be specified, then multiple respective rules can be added to the ruleset. Note that if there are multiple requesters (owners), different rulesets may be used for the different requesters (or groups of requesters) by the command filter.

The memory controller can include a bus interface controller connected to a bus to which the memory is connected. For example, the bus interface controller can include a Serial Peripheral Interface (SPI) controller if the bus is a SPI bus. Alternatively, the memory controller can include an embedded multi-media card (eMMC) or any other type of memory controller.

The computer system can include multiple domains of different trust levels. The security system can be part of a secure domain (also referred to as a "secure enclave") that is trusted. However, other components may be in other domains that are untrusted or semi-trusted. For example, the computer system may include a management controller that is part of a semi-trusted domain, and a system central processing unit (CPU) of the computer system may be part of an untrusted domain. Each of the foregoing domains can execute machine-readable instructions, including firmware and software, at varying trust levels depending on which domain the machine-readable instructions execute within.

In accordance with some examples of the present disclosure, an entity in a trusted domain (e.g., the security system in the secure enclave) can be used to modify rulesets of command filters in domains of lower trust levels. In some examples, both trusted and semi-trusted domains may share a common boot nonvolatile memory containing boot code. In such examples, a command filter can be used to set different level of access rights to different domains. For example, the trusted domain including the security controller may be allowed to both read and write to a segment of the boot nonvolatile memory whereas the semi-trusted domain including the management controller may be allowed to only read from the boot nonvolatile memory.

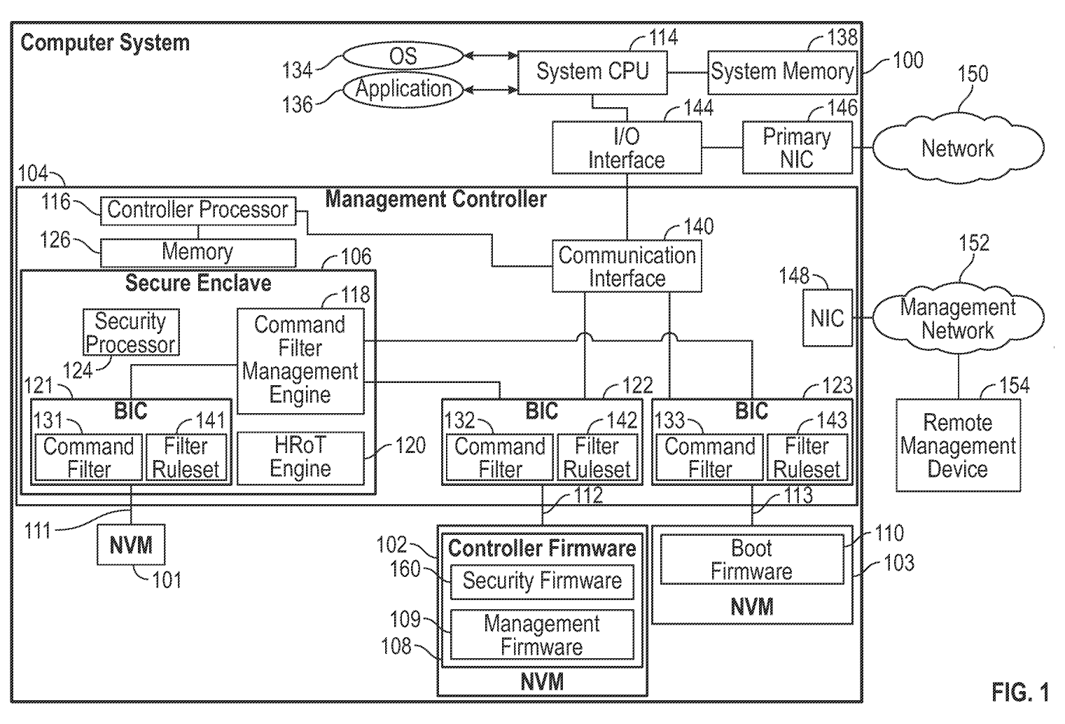

FIG. 1 is a block diagram of an example computer system 100. The computer system can include one or more computers. The computer system 100 includes a number of nonvolatile memories (NVMs) 101, 102, and 103. Although three NVMs are shown in FIG. 1, in other examples, a different quantity of NVMs (less than three or more than three) may be present. Also, although FIG. 1 refers to an example in which command filters are used to control access to NVMs, in another example, a command filter may be used to control access to a volatile memory.

The NVMs 101, 102, and 103 are accessible over respective buses 111, 112, and 113. In some examples, the buses 111 to 113 may be serial buses (also referred to as serial links) over which data is transferred as a serial stream (e.g., one bit at a time) across a data line. In other examples, the buses 111 to 113 may include parallel buses over which data can be transferred as multiple bits across multiple data lines. In further examples, multiple NVMs may be connected to a given bus.

Bus interface controllers (BICs) 121, 122, and 123 manage access to the respective NVMs 101, 102, and 103 over the buses 111, 112, and 113. A BIC can receive an NVM access request to access an NVM. Examples of NVM access requests include any or some combination of the following: a write request (also referred to as a "program request") to write data to an NVM, a read request to read data from the NVM, an erase request to erase content in the NVM (e.g., a bulk erase request to erase the entirety of the NVM or a sector erase request to erase a sector of the NVM), a register write request to write a register of the NVM, a register read request to read a register of the NVM, a suspend request to suspend access to the NVM, a resume request to resume access to the NVM after suspension, or other access requests.

A BIC includes a command filter to filter NVM access requests for approving or denying the NVM access requests. If the command filter approves an NVM access request, then the BIC generates signals on the respective bus to perform the requested access to the NVM. If the command filter denies an NVM access request, the NVM access request is blocked and the BIC does not generate signals on the respective bus to access the NVM. The BIC 121 includes a command filter 131, the BIC 122 includes a command filter 132, and the BIC 123 includes a command filter 133.

Each command filter applies filtering of NVM access request according to a respective filter ruleset. The command filter 131 applies filter according to a filter ruleset 141, the command filter 132 applies filter according to a filter ruleset 142, and command filter 133 applies filter according to a filter ruleset 143. A filter ruleset can include an allow list of NVM access requests that are permitted for access to an NVM memory and/or a deny list of NVM access requests that are to be rejected by the command filter. A "list" of access requests includes information identifying the access requests. The list can be in machine-readable form.

In some examples, the filter ruleset can also specify additional criteria regarding whether an access request is to be allowed or rejected. The additional criteria can include an ownership criterion, an address range criterion, or any other criterion.

In some examples, the buses 111 to 113 are Serial Peripheral Interface (SPI) buses. In such examples, the BICs 121 to 123 are SPI interface controllers. In other examples, any of the buses 111 to 113 can include a system management bus (SMB), an Inter-Integrated Component (I²C) bus, an Improved I²C (I³C) bus, or any other type of bus.

More generally, the BICs 121 to 123 (or portions of such BICs) are memory controllers that manage access to memories such as the NVMs 101 to 103.

In some examples, the BICs 121, 122, and 123 are part of a management controller 104. The management controller 104 can be a baseboard management controller (BMC) in some examples. In other examples, the management controller 104 can be a different type of controller that performs management tasks with respect to the computer system 100. The management controller 104 may be implemented using a single integrated circuit (IC) device (e.g., a die or an integrated package) or a collection of IC devices (which can be mounted on a circuit board, for example).

In some examples, the management controller 104 also includes a secure enclave 106. In other examples, the secure enclave 106 may be separate from the management controller 104. The secure enclave is a subsystem for which access into and out of the subsystem is tightly controlled (e.g., access is permitted to specific entities and under specific conditions). The secure enclave 106 is part of a security plane that performs cryptographic security-related functions for components of the computer system 100.

In an example, the NVM 101 that is managed by the BIC 121 in the secure enclave 106 forms part of the secure memory for the management controller 104. For example, the NVM 101 can store data representing cryptographic artifacts (cryptographic keys, digital certificates, cryptographic seeds, cryptographic secrets, passwords or other security-related information). The NVM 101 may further store other sensitive information that is to be protected against unauthorized access.

The NVM 102 that is managed by the BIC 122 can store controller firmware 108. The controller firmware 108 can include security firmware 160 to be executed by a security processor 124 in the secure enclave 106, and management firmware 109 executable by a controller processor 116 of the management controller 104. The security processor 124, the controller processor 116, and a system central processing unit (CPU) 114 are separate from one another.

In some examples, the management firmware 109 may include an OpenBMC firmware stack, which is an open-source implementation of management firmware for execution by a BMC. An OpenBMC firmware stack includes a collection of firmware code according to the OpenBMC project. In other examples, the management firmware 109 may include proprietary firmware, which can be developed by a manufacturer or other provider of the computer system 100.

The NVM 103 can store boot firmware 110, such as Basic Input/Output System (BIOS) code or Universal Extensible Firmware Interface (UEFI) code that is executable by the system CPU 114 of the computer system 100. In other examples, the boot firmware 110 can be stored in the NVM 102. Also, although FIG. 1 shows the NVMs 102 and 103 managed by different BICs 122 and 123, in other examples, the NVM 102 storing the controller firmware 108 (containing the security firmware 160 and the management firmware 109) and the NVM 103 storing the boot firmware can be managed by the same BIC using memory specific rulesets in the command filter of the BIC.

Although reference is made to specific example content stored in respective NVMs, note that the NVMs 101 to 103 can store other information in other examples. For example, an NVM can store software for execution by the controller processor 116 or the system CPU 114, configuration or management data, and/or other information.

In accordance with some examples of the present disclosure, a command filter management engine 118 in the secure enclave 106 can update any of the command filters 131 to 133 by modifying a ruleset of the respective command filter. The command filter management engine 118 can update a command filter in response to detecting a changed condition in the computer system 100. An example of a changed condition includes a change of the management firmware 109 (or other program code) for the management controller 104. In a specific example, the management firmware 109 can be updated to include an OpenBMC firmware stack. When the computer system 100 was developed for a customer, the NVM 102 may store a proprietary management firmware stack created by the manufacturer or other provider of the computer system 100. The customer may decide to replace the proprietary management firmware stack with an OpenBMC firmware stack, either prior to or after taking delivery of the computer system 100. In other examples, the NVM 102 may initially store a first OpenBMC firmware stack created by manufacturer or other provider of the computer system 100. The customer may replace the first OpenBMC firmware stack with a different second OpenBMC firmware stack.

The command filter management engine 118 can detect the change in the management firmware for the management controller 104, and in response, the command filter management engine 118 can update a filter ruleset for a command filter, such as the filter ruleset 142 for the command filter 132 in the BIC 122. Note that the update of the filter ruleset performed by the command filter management engine 118 can include a simple update of a register in the command filter using information from the NVM 101 (or another NVM) and in response to a command from the controller processor 116.

Other examples of changed conditions include infestation of the computer system 100 by malware or the occurrence of bugs leading to errors or faults in the computer system 100. It may be determined that a command filter should be changed in response to detecting the malware or a bug. A requester (e.g., program code executed by the controller processor 116 in the management controller 104 or program code executed by the system CPU 114 or another entity whether inside or outside the computer system 100) may send a command filter update request to the secure enclave 106 to modify the filter ruleset(s) of one or more command filters.

In response to the command filter update request, the command filter management engine 118 can check a policy stored at the secure enclave 106, such as in the NVM 101 or a secure memory within the secure enclave 106, to determine whether the command filter update request is allowed. The policy may specify that the command filter update request is allowed if issued by a trusted entity and under certain conditions (e.g., during initial boot of the computer system 100). The determination of whether an entity that issued the command filter update request can be trusted can be based on checking a signature in the command filter update request or checking a credential provided by the entity. If the command filter management engine 118 determines based on the policy that the command filter update request is allowed, the command filter management engine 118 performs an update of the filter ruleset(s) of one or more command filters. If the command filter management engine 118 determines based on the policy that the command filter update request is not allowed, the command filter management engine 118 drops the command filter update request.

As an example, if an entity (e.g., a human, a program, or a machine) associated with the computer system 100 determines that the computer system 100 has been stolen or is about to come into the possession of an unauthorized person, then the entity may wish to remove secrets and/or other sensitive information stored in one or more NVMs, a process referred to as zeroization. The zeroization can effectively disable the computer system 100. To support zeroization, command filter(s) can be updated to allow a bulk erase request so that the contents of the NVM(s) are destroyed.

The secure enclave 106 further includes a HRoT engine 120 and the security processor 124. Although the command filter management engine 118 is shown as separate from the HRoT engine 120 and the security processor 124, it is noted that in some examples, the command filter management engine 118 may be part of the HRoT engine 120 and/or the security processor 124. For example, the command filter management engine 118 can include logic to perform an update of a register in the command filter using information from the NVM 101 (or another NVM) and in response to a command from the controller processor 116.

The HRoT engine 120 is a trust anchor for the computer system's chain of trust. Responsive to receiving power, the HRoT engine 120 holds the security processor 124, the controller processor 116, and the system CPU 114 in reset, which prevents the security processor 124, the controller processor 116, and the system CPU 114 from operating until a validation process of the HRoT engine 120 is successfully completed.

As part of the validation process, the HRoT engine 120 acquires a hardware integrity measurement of the HRoT engine 120 and acquires an integrity measurement of the security firmware 160 of the controller firmware 108 stored in the NVM 102. The integrity measurement of the security firmware 160 is referred to as "firmware integrity measurement." The HRoT engine 120 can combine (e.g., concatenate) the hardware integrity measurement and the firmware integrity measurement to form an input value, and the HRoT engine 120 computes a fingerprint (e.g., a hash) based on the input value. The HRoT engine 120 controls whether the security firmware 160 is executed based on the computed fingerprint. If the HRoT engine 120 determines that the computed fingerprint matches an immutable reference (an expected fingerprint), the HRoT engine 120 releases the security processor 124 from reset, loads the security firmware 160 to a memory (not shown) of the secure enclave 106, and allows execution of the security firmware 160 on the security processor 124 to allow a trusted boot of the computer system 100 to proceed. If the HRoT engine 120 determines that the computed fingerprint does not match the expected fingerprint, then the HRoT engine 120 does not allow execution of the security firmware 160 , and consequently, prevents a trusted boot of the computer system 100 from proceeding.

The HRoT engine 120 performing the foregoing validation is part of a self-validation by the secure enclave 106. In addition to the self-validation performed by the HRoT engine 120, the validation process further includes a validation of additional program code. Specifically, the security firmware 160 executed by the security processor 124 can validate a portion of the management firmware 109. In response to validating the portion of the management firmware 109, the security processor 124 loads the portion of the management firmware 109 into a memory 126 of the management controller 104, and the HRoT engine 120 releases the controller processor 116 of the management controller 104 from reset. Responsive to being released from reset, the controller processor 116 executes the loaded portion of the management firmware 109, which causes the management controller 104 to load additional portions of the management controller 104 for execution by the management controller 104. Note that the chain of trust may include further validations.

The management firmware 109 executed by the controller processor 116 can further validate the boot firmware 110. If the boot firmware 110 is successfully validated, the management firmware 109 loads the boot firmware 110 for execution by the system CPU 114, and the HRoT engine 120 releases the system CPU 114 from reset. The system CPU 114 executes the boot firmware 110 to complete the trusted boot process of the computer system 100.

The boot process also loads an operating system (OS) 134 for execution by the system CPU 114. One or more application programs 136 can also execute on the system CPU 114. The system CPU 114 is connected to a system memory 138 (e.g., a volatile memory) in which machine-readable instructions and data can be stored.

The management controller 104 includes a communication interface 140 through which components in the management controller 104 can communicate with components of the computer system 100 outside the management controller 104. In an example, the communication interface 140 contains registers that are associated with an application programming interface (API) that is provided by the management controller 104. Through the API, a program executed by the system CPU 114 may communicate with the management controller 104 using an input/output control (IOCTL) interface driver, representational state transfer (REST) API calls (e.g., Redfish API calls), or some other system software proxy. In some examples, the communication interface 140 may include a Peripheral Component Interconnect Express (PCIe) interface, Enhanced Serial Peripheral Interface (eSPI), or another interface over which API requests may be transferred.

The computer system 100 includes an input/output (I/O) interface 144, such as an I/O bridge, that is connected to the communication interface 140 of the management controller 104. The I/O interface 144 is also connected to a primary network interface controller (NIC) 146 of the computer system 100, through which the computer system 100 can communicate with a network 150.

The management controller 104 also includes a NIC 148 that may be separate from the NIC 146. The NIC 148 of the management controller 104 allows the management controller 104 to communicate over a management network 152 that may be separate from the network 150. A remote management device 154 can communicate over the management network 152 to perform management tasks in the computer system 100. In further examples, the remote management device 154 can communicate over the management network 152 through the primary NIC 146 to perform management tasks in the computer system 100.

As shown in the example of FIG. 1, multiple different domains are present that have different trust levels. The secure enclave 106 forms a trusted domain at the highest trust level. The portion of the management controller 104 outside the secure enclave 106 is part of a management domain that has a second trust level that is below the highest trust level of the secure enclave 106. The components of the computer system 100 outside the management controller 104 are part of a host domain having a third trust level that is below the second trust level.

Although three domains are referenced, in other examples, there may be a different quantity of domains with respective different trust levels.

Components of the different domains can issue NVM access requests to BICs for accessing respective NVMs. For example, the security processor 124 can issue NVM access requests to the BIC 121 to access the NVM 101. In some examples, components outside the secure enclave 106 are not able to issue NVM access requests to the BIC 121 inside the secure enclave 106.

The controller processor 116 of the management controller 104 and the system CPU 114 are able to issue NVM access requests to the BICs 122 and 123 to access the respective NVMs 102 and 103.

In accordance with some examples of the present disclosure, the secure enclave 106 (and more specifically, the command filter management engine 118 in the secure enclave 106) of the trusted domain can update filter rulesets 141, 142, and 143 for the respective command filters 131, 132, and 133.

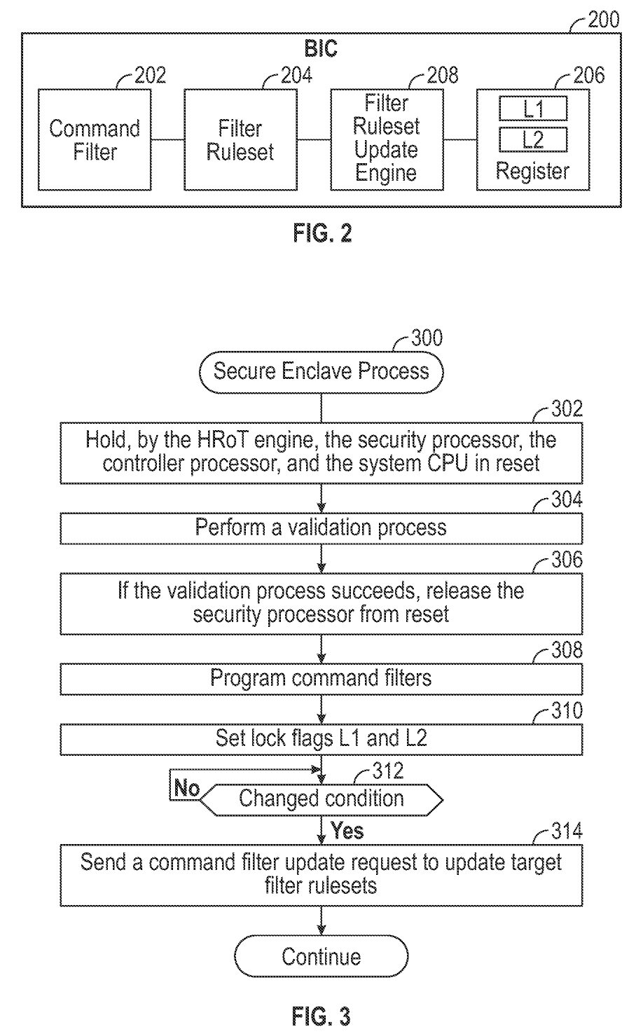

FIG. 2 is a block diagram of a BIC 200, which can be the BIC 121, 122, or 123 of FIG. 1. The BIC 200 includes a command filter 202, which can be the command filter 132 or 133 of FIG. 1, and a filter ruleset 204, which can be the filter ruleset 142 or 143 of FIG. 1.

Additionally, the BIC 200 includes a register 206 (or another storage element such as the BIC's memory) to store lock flags L1 and L2 that represent locks to control whether the filter ruleset 204 can be updated, and by which entity. A lock flag can be implemented using one or more bits. The values of L1 and L2 can be controlled by the command filter management engine 118. Although shown as being outside the command filter 202, the register 206 may be part of the command filter 202.

The secure enclave 106 has write access to the register 206 for setting or modifying the values of L1 and L2 in the register 206. Another entity outside the secure enclave 106 does not have write access to the register 206 for setting or modifying L1 and L2. The secure enclave 106 can set the values of L1 and L2 during initialization of the computer system 100.

The lock flag L1 controls whether a program outside the secure enclave (e.g., the OS 134 and an application program 136 executed by the system CPU 114 or the management firmware 109 executed by the controller processor 116) is allowed to update the filter ruleset 204. The lock flag L2 controls whether the secure enclave 106 is allowed to update the filter ruleset 204. A lock flag if set to a first value (e.g., "0") specifies that an update of the filter ruleset 204 is permitted, and the lock flag if set to a different second value (e.g., "1") specifies that an update of the filter ruleset 204 is not permitted. For example, if L1 is set to “1” but L2 is “0,” an entity outside the secure enclave 106 (such as a program executed by the controller processor 116 or the system CPU 114) is not allowed to update the filter ruleset 204. However, the secure enclave 106 can still update the command filter 202. On the other hand, if both L1 and L2 are set to “1,” even the secure enclave 106 is not allowed to update the filter ruleset 204.

If L2 is set to “0,” then the command filter management engine 118 in the secure enclave 106 is allowed to update the filter ruleset 204. If L2 is set to the “1,” then the command filter management engine 118 is not allowed to update the filter ruleset 204. In the latter case, a reboot of the computer system 100 can reset L2 to “0” so that the command filter management engine 118 can update the filter ruleset 204.

The BIC 200 includes a filter ruleset update engine 208 that can receive a command filter update request, either from the secure enclave 106 or an entity outside the secure enclave 106. In response to receiving the command filter update request from an entity outside the secure enclave 106, the filter ruleset update engine 208 checks the value of the lock flag L1. If L1 is set to the second value (e.g., "1"), the filter ruleset update engine 208 rejects the command filter update request and the filter ruleset 204 is not updated. On the other hand, if L1 is set to the first value (e.g., "0"), the filter ruleset update engine 208 can update the filter ruleset 204 according to the command filter update request. The update can include adding or removing one or more entries of an allow list of NVM access requests and/or a deny list of NVM access requests. The update can include changing an ownership criterion and/or an address range criterion.

In response to receiving the command filter update request from the secure enclave 106, the filter ruleset update engine 208 checks the value of the lock flag L2. If L2 is set to the second value (e.g., "1"), the filter ruleset update engine 208 rejects the command filter update request and the filter ruleset 204 is not updated. On the other hand, if L2 is set to the first value (e.g., "0"), the filter ruleset update engine 208 can update the filter ruleset 204 according to the command filter update request from the secure enclave 106.

The following refers to FIG. 1 and FIG. 3. FIG. 3 is a flow diagram of a process 300 of the secure enclave 106 according to some examples of the present disclosure. In response to initially receiving power during a power up procedure of the computer system 100, the HRoT engine 120 holds (at 302) the security processor 124, the controller processor 116, and the system CPU 114 in reset. The HRoT engine 120 performs (at 304) a validation process. If the validation process succeeds, the HRoT engine 120 releases (at 306) the security processor 124 from reset to execute the security firmware 160 of the controller firmware 108.

In some examples, the command filter management engine 118 can be implemented with machine-readable instructions that are part of the security firmware 160 executed by the security processor 124. Once the security processor 124 is released from reset, the command filter management engine 118 can execute on the security processor 124 to program (at 308) the command filters 131, 132, and 133 by setting the respective filter rulesets 141, 142, and 143. For example, the filter rulesets 141, 142, and 143 may be retrieved from the NVM 101 (or another NVM) and written to registers of the respective command filters 131, 132, and 133.

The command filter management engine 118 can also set (at 310) lock flags L1, L2 (to respective "0" or "1" values) for the respective BICs 121, 122, and 123. For example, the command filter management engine 118 can write to respective registers 206 in the BICs 121, 122, and 123.

At a later time, the command filter management engine 118 determines (at 312) whether a changed condition is present that should trigger an update of target filter rulesets (e.g., one or more of the filter rulesets 141, 142, and 143). If the changed condition is not present, the command filter management engine 118 continues with the secure enclave process 300 without changing any filter ruleset. However, if the changed condition is present, the command filter management engine 118 sends (at 314) a command filter update request to update the target filter rulesets. The command filter update request is sent to one or more of the BICs 121, 122, and 123. In response to the command filter update request, a filter ruleset update engine (e.g., 208 in FIG. 2) in the BIC that receives the command filter update request can perform an update of the respective filter ruleset, subject to the lock flag L2 in the BIC.

The changed condition that should trigger an update of the target filter rulesets can include a modification of the management firmware 109 in the NVM 102, such as by a customer that replaces an initially loaded management firmware stack with a different management firmware (e.g., an OpenBMC firmware stack).

Another changed condition that should trigger an update of the target filter rulesets can include a detection of malware or a bug. In this latter example, the command filter management engine 118 in the secure enclave 106 can check a policy stored in the secure enclave 106 to determine whether a request to update the target filter rulesets is allowed in light of the detected malware or bug. If the policy allows the update, the command filter management engine 118 sends a command filter update request to update the target filter rulesets.

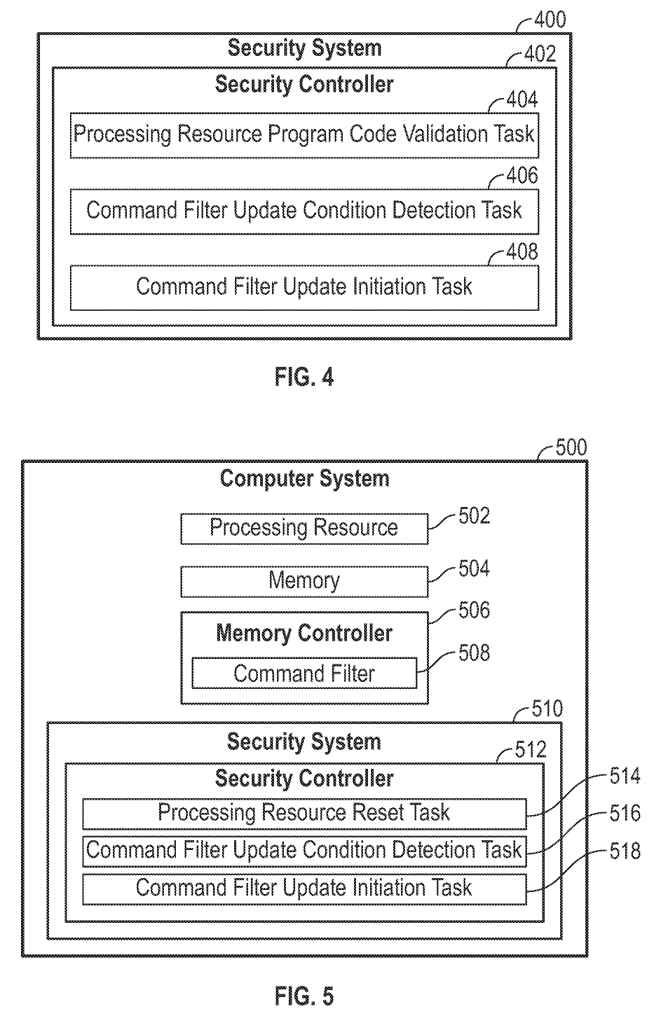

FIG. 4 is a block diagram of a security system 400 according to some examples of the present disclosure. In an example, the security system 400 includes the secure enclave 106 of FIG. 1.

The security system 400 includes a security controller 402 to perform various tasks. The security controller 402 can include any or some combination of the following elements of FIG. 1: the HRoT engine 120, the security processor 124, and the command filter management engine 118.

The tasks of the security controller 402 include a processing resource program code validation task 404 to, during an initialization of a computer system, validate program code to be run on a processing resource outside a security boundary of the security system. The processing resource may be the controller processor 116 in the management controller 104 of FIG. 1, and/or the system CPU 114 in the computer system 100.

The tasks of the security controller 402 include a command filter update condition detection task 406 to detect a condition triggering an update of a command filter in a memory controller for a memory. The command filter may be part of a BIC (e.g., 121, 122, or 123 in FIG. 1) or part of another type of memory controller.

The tasks of the security controller 402 include a command filter update initiation task 408 to, based on detecting the condition, initiate an update the command filter. For example, the security controller 402 can send a command filter update request to the memory controller to request the update of the command filter.

In some examples, the condition triggering the update of the command filter includes a change of the program code from a first program code to a second program code. For example, the first program code can be the program code initially loaded in the memory when the computer system is delivered to a customer, and the second program code can be loaded into the memory by the customer to replace the first program code. The first and second program code may include different management controller programs, for example, such as an initially loaded proprietary management firmware and an open-source firmware stack (e.g., an OpenBMC firmware stack). In further examples, the first and second program code may include different open-source firmware stacks. In other examples, the first and second program code can include other types of machine-readable instructions.

In some examples, the updating of the command filter includes changing a ruleset for the command filter.

In some examples, the ruleset includes one or more of an allow list of access requests to access the memory or a deny list of access requests to access the memory.

In some examples, the ruleset includes an ownership criterion relating to whether an owner that issued an access request to the memory is approved.

In some examples, the ruleset includes an address range criterion relating to whether an access request to the memory targets a permitted address range of the memory.

In some examples, the condition triggering the update of the command filter includes a detection of malware or a bug in the computer system.

In some examples, the security controller 402 can receive a request to update the command filter, the request being responsive to the condition. For example, the request may be received by the security system 400 from a requester that received an indication of malware infection from a malware detector. As another example, the request may be received by the security system 400 from a requester that received an indication of a bug in the computer system, where the bug can include an error, a fault, or a failure. The security controller 402 can determine, based on a policy stored in the security system 400, whether the request to update the command filter is permitted. The security controller 402 can accept or reject the request to update the command filter based on the determining.

In some examples, the security controller 402 includes a hardware root of trust and is part of a trusted domain. The memory contains information of a domain having a trust level lower than a trust level of the trusted domain. The domain may be the domain of the management controller 104 outside the secure enclave 106 of FIG. 1. Alternatively, the domain may be the host domain including the system CPU 114.

In some examples, the update of the command filter is performed without rebooting the computer system.

In some examples, the security system 400 further includes a security system memory to store a lock indicator that when set prevents the processing resource from updating the command filter. The lock indicator may be L2 in FIG. 2.

In some examples, the security system memory further stores a second lock indicator that when set prevents the security controller 402 from updating the command filter. The second lock indicator may be L1 in FIG. 2.

In some examples, the second lock indicator is reset responsive to a reboot of the computer system.

FIG. 5 is a block diagram of a computer system 500 according to some examples of the present disclosure. An example of the computer system 500 is the computer system 100 of FIG. 1.

The computer system 500 includes a processing resource 502, which includes one or more hardware processors. The processing resource 502 may be the controller processor 116 in the management controller 104 of FIG. 1. Alternatively or additionally, the processing resource 502 includes the system CPU 114 of FIG. 1.

The computer system 500 includes a memory 504. The memory 504 may be an NVM or a volatile memory, or both. The computer system 500 includes a memory controller 506 including a command filter 508 to control access to the memory 504. An example of the memory controller 506 is the BIC 122 or 123 of FIG. 1. In other examples, the memory controller 506 can be a different type of memory controller.

The computer system 500 includes a security system 510 having a security controller 512 to perform various tasks. The security system 510 may include the secure enclave 106 of FIG. 1.

The security controller 512 can perform various tasks. The tasks of the security controller 512 include a processing resource reset task 514 to, during an initialization of the computer system 500, hold the processing resource in reset and perform a validation process. The processing resource 502 is in a domain having a trust level lower than a trust level of a trusted domain including the security system 510. In some examples, the validation process includes a validation of the security system (self-validation) and a validation of program code to be executed on the processing resource 502.

The tasks of the security controller 512 include a command filter update condition detection task 516 to detect a condition triggering an update of a command filter 508. The condition can include a modification of program code (e.g., management controller programs), a detection of malware, or a detection of a bug.

The tasks of the security controller 512 include a command filter update initiation task 518 based on detecting the condition, update the command filter.

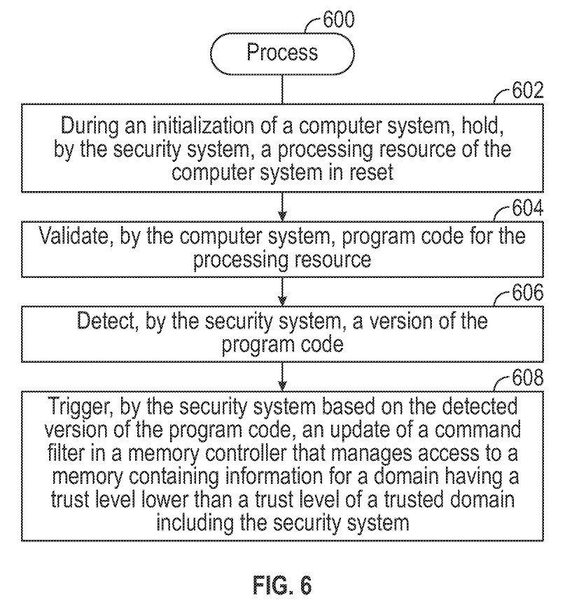

FIG. 6 is a flow diagram of a process 600 according to some examples of the present disclosure. The process 600 can be performed by a security system, such as the secure enclave 106 of FIG. 1.

The process 600 includes during an initialization of a computer system, holding (at 602), by the security system, a processing resource of the computer system in reset. The processing resource can include the controller processor 116 and/or the system CPU 114.

The process 600 includes validating (at 604), by the security system, program code for the processing resource. The program code validated can include the management firmware 109 and/or the boot firmware 110 of FIG. 1.

The process 600 includes detecting (at 606), by the security system, a version of the program code. In some examples, the program code may include a first version loaded by a provider of the computer system, and a second version loaded by a customer of the computer system.

The process 600 includes triggering (at 608), by the security system based on the detected version of the program code, an update of a command filter in a memory controller that manages access to a memory containing information for a domain having a trust level lower than a trust level of a trusted domain comprising the security system. The security system can change the command filter of the domain having the lower trust level without having to be provided information regarding the domain of the lower trust level. Note that the update of the command filter can be performed during initialization or at runtime.

As used here, a "controller" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a "controller" can refer to a combination of one or more hardware processing circuits and machine-readable instructions (software and/or firmware) executable on the one or more hardware processing circuits.

A hardware processor can include a microprocessor, a core of a multi-core microprocessor, a microcontroller, a programmable integrated circuit, a programmable gate array, or another hardware processing circuit.

FIGS. 3 and 6 are flow diagrams of processes including tasks performed in depicted orders. In other examples, the tasks of any of the processes may be performed in a different order, some of the tasks may be omitted, and other tasks may be added.

A "BMC" can refer to a specialized service controller that monitors the physical state of a computer system using sensors and communicates with a remote management system (that is remote from the computer system) through an independent "out-of-band" connection. The BMC can perform management tasks to manage components of the computer system. Examples of management tasks that can be performed by the BMC can include any or some combination of the following: power control to perform power management of the computer system (such as to transition the computer system between different power consumption states in response to detected events), thermal monitoring and control of the computer system (such as to monitor temperatures of the computer system and to control thermal management states of the computer system), fan control of fans in the computer system, system health monitoring based on monitoring measurement data from various sensors of the computer system, remote access of the computer system (to access the computer system over a network, for example), remote reboot of the computer system (to trigger the computer system to reboot using a remote command), system setup and deployment of the computer system, system security to implement security procedures in the computer system, and so forth.

In some examples, the BMC can provide so-called "lights-out" functionality for the computer system. The lights out functionality may allow a user, such as a systems administrator, to perform management operations on the electronic device even if an OS is not installed or not functional on the computer system.

Moreover, in some examples, the BMC can run on auxiliary power provided by an auxiliary power source; as a result, the computer system does not have to be powered on to allow the BMC to perform the BMC's operations. The auxiliary power source is separate from a primary power supply that supplies powers to other components (e.g., a main processor, a memory, an I/O device, etc.) of the computer system.

A storage medium can store machine-readable instructions executable in a system. The storage medium can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A security system for a computer system, the security system comprising:
a security controller to:
during an initialization of the computer system, validate program code to be run on a processing resource outside a security boundary of the security system;
detect a condition triggering an update of a command filter in a memory controller for a memory; and
based on detecting the condition, initiate an update of the command filter.

2. The security system of claim 1, wherein the processing resource is part of a management controller of the computer system.

3. The security system of claim 2, wherein the condition triggering the update of the command filter comprises a change of the program code from a first program code to a second program code.

4. The security system of claim 3, wherein the first program code and the second program code comprise different management controller programs.

5. The security system of claim 4, wherein at least one of the different management controller programs comprises an open-source firmware stack.

6. The security system of claim 1, wherein the updating of the command filter comprises changing a ruleset for the command filter.

7. The security system of claim 6, wherein the ruleset comprises one or more of an allow list of access requests to access the memory or a deny list of access requests to access the memory.

8. The security system of claim 6, wherein the ruleset comprises an ownership criterion relating to whether an owner that issued an access request to the memory is approved.

9. The security system of claim 6, wherein the ruleset comprises an address range criterion relating to whether an access request to the memory targets a permitted address range of the memory.

10. The security system of claim 1, wherein the condition triggering the update of the command filter comprises a detection of malware or a bug in the computer system.

11. The security system of claim 1, wherein the security controller is to:
receive a request to update the command filter, the request being responsive to the condition;
determine, based on a policy stored in the security system, whether the request to update the command filter is permitted;
accept or reject the request to update the command filter based on a result of the determining.

12. The security system of claim 1, wherein the security controller comprises a hardware root of trust and is part of a trusted domain, and wherein the memory contains information of a domain having a trust level lower than a trust level of the trusted domain.

13. The security system of claim 1, wherein the update of the command filter is performed without rebooting the computer system.

14. The security system of claim 1, wherein the security controller is to set a lock indicator in a register to prevent the processing resource from updating the command filter.

15. The security system of claim 14, wherein the register is to further store a second lock indicator that when set prevents the security controller from updating the command filter, wherein the second lock indicator is reset responsive to a reboot of the computer system.

16. A computer system comprising:
a processing resource;
a memory;
a memory controller comprising a command filter to control access to the memory; and
a security system comprising a security controller to:
during an initialization of the computer system, hold the processing resource in reset and perform a validation process, wherein the processing resource is in a domain having a trust level lower than a trust level of a trusted domain comprising the security system;
detect a condition triggering an update of the command filter; and
based on detecting the condition, initiate an update of the command filter.

17. The computer system of claim 16, wherein the validation process comprises a validation of the security system and a validation of program code to be executed on the processing resource.

18. The computer system of claim 16, wherein the security controller comprises a hardware root of trust and a security processor.

19. A method comprising:
during an initialization of a computer system, holding, by a security system, a processing resource of the computer system in reset;
validating, by the security system, program code for the processing resource;
detecting, by the security system, a version of the program code; and
based on the detected version of the program code, triggering, by the security system, an update of a command filter in a memory controller that manages access to a memory containing information for a domain having a trust level lower than a trust level of a trusted domain comprising the security system.

20. The method of claim 19, further comprising:
detecting, by the security system, an indication of malware or a bug in the computer system; and
based on detecting the indication of the malware or the bug, triggering, by the security system, an update of the command filter.
